(19) United States
(12) Patent Application Publication
(10) Pub. No.: US 2007/0041638 A1
(43) Pub. Date: Feb. 22, 2007

(54) Systems and methods for real-time object recognition

(76) Inventors: Xiuwen Liu, Tallahassee, FL (US); Washington Mio, Tallahassee, FL (US)

Correspondence Address: SUTHERLAND ASBILL & BRENNAN LLP, 999 PEACHTREE STREET, N.E., ATLANTA, GA, 30309, US

(21) Appl. No.: 11/413,696

(22) Filed: Apr. 28, 2006

Related U.S. Application Data
(60) Provisional application No. 60/675,816, filed on Apr. 28, 2005.

(51) Int. Cl. G06K 9/00

(52) U.S. Cl. 382/170

(57) ABSTRACT

Systems and methods are provided for the real-time object recognition of target objects, which includes the identification of target objects within images. In particular, images are received from an imaging device and analyzed by a workstation. The workstation applies one or more filters to the received images to generate one or more filtered images. One or more windows (e.g., sub-regions, sub-rectangles, etc.) of the filtered images are then analyzed in order to obtain histogram features. The workstation obtains a representation of these histogram features, which may be a simplified version or reduced dimension of the histogram features. The workstation then applies classifiers to the representation of the histogram features to recognize any objects in the received images.

### RELATED APPLICATIONS

The present application claims benefit of U.S. Provisional Application Ser. No. 60/675,816, filed Apr. 28, 2005 and entitled “Systems and Methods for Real-Time Object Recognition,” which is incorporated herein in its entirety by reference.

### BACKGROUND OF THE INVENTION

I. Field of the Invention

The present invention relates generally to machine vision systems, and more particularly to machine vision systems for the real-time recognition of desired target objects.

II. Description of Related Art

Imaging technology has advanced in recent decades such that many government agencies and private firms now use this imaging technology for security and surveillance. For example, government agencies are exploiting this imaging technology to monitor and secure sites such as airports, buildings, transportation hubs, and areas near critical infrastructure or containing sensitive information. Likewise, private firms such as companies, stores, and outlets are using imaging technology that includes closed circuit television (CCTV) cameras and other sensors to monitor and secure buildings and industrial sites and to monitor personnel and activities.

The use of prior imaging technology oftentimes requires one or more human operators to review the images and/or video generated from the imaging technology. The large amount of images and/or video can be challenging, burdensome, and costly to review. Furthermore, the review of the images and/or video can be subject to human error, especially if the review is being performed in real-time.

However, the above-described imaging technology does not provide automated real-time recognition of objects, including the real-time recognition of human faces. Detection of an object involves identifying the object as belonging to a broad class, while recognition involves inferring finer individual characteristics and identifying the specific object. Accordingly, there is a need in the industry for an automated machine vision system that can screen and analyze image and/or video content, and recognize desired objects in real-time.

### SUMMARY OF THE INVENTION

According to an embodiment of the present invention, there is a method for real-time object recognition. The method includes receiving at least one image from at least one imaging device and obtaining a plurality of histogram features from the at least one image, where obtaining the plurality of histogram features includes applying one or more filters to the received images to generate one or more filtered images and analyzing one or more windows of the filtered images for obtaining the histogram features. The method further includes obtaining at least one representation of the histogram features and recognizing an object in the at least one received image by applying one or more classifiers to the representation of the histogram features.

According to an aspect of the present invention, analyzing one or more windows of the filtered images may include a summation of a plurality of pixels of the one or more windows. According to another aspect of the present invention, recognizing the object may include recognizing the object by traversing one or more nodes of a decision tree until a terminal node is reached, where each node of the decision tree specifies the filters to be applied, the windows to be analyzed, and the one or more classifiers to be applied to the representation of the histogram features. The classifiers of the decision tree may be determined by comparing training set images to cross-validation set images. According to another aspect of the present invention, obtaining at least one representation of the filtered images includes projecting at least a portion of the histogram features onto a subspace of the histogram features space. In addition, at least one of the classifiers may also operate in the subspace. According to yet another aspect of the present invention, recognizing the object may include recognizing the object in the at least one received image by applying one or more classifiers to the representation of the histogram features in accordance with one of optimal component analysis and splitting factor analysis.

According to another embodiment of the present invention, there is a method for training a vision system for real-time object recognition. The method includes receiving a plurality of training data having a plurality of classes of target objects and backgrounds, where the training data includes training set images and cross-validation set images for each class, retrieving histogram features from the training data, where each histogram feature is associated with a filter and a window, determining optimal histogram features for one or more classes, and storing classifiers for the optimal histogram features in one or more nodes of a decision tree, where each node of the decision tree provides for discrimination between classes based upon representations of histogram features retrieved from input images.

According to an aspect of the present invention, determining the optimal histogram features may include determining the recognition performance of the histogram features of the training set images when applied to the cross-validation set images. According to another aspect of the present invention, the method may further include clustering at least a portion of the plurality of classes in order to obtain a smaller number of classes of target objects and backgrounds. According to another aspect of the present invention, the method may further include storing filters and windows associated with the optimal histogram features in one or more nodes of the decision tree, where the nodes determine at least in part which histogram features are retrieved. According to yet another aspect of the present invention, receiving a plurality of training data may include receiving, for each class of target objects, images of target objects at varying scales. According to still another aspect of the present invention, retrieving histogram features may include applying one or more filters to the training data, obtaining a window of the filtered training data, and performing a summation of a plurality of pixels within the window.

According to another embodiment of the present invention, there is a system for real-time object recognition. The system includes an imaging device for providing input images and a workstation in communication with the imaging device for receiving the at least one input image. The workstation is operative to apply one or more filters to the at least one input image to generate one or more filtered images, analyze one or more windows of the filtered images to obtain the histogram features, obtain at least one representation of the histogram features, and recognize an object in the at least one received image by applying one or more classifiers to the representation of the histogram features.

According to an aspect of the present invention, the histogram features may be associated with a summation of a plurality of pixels of the one or more windows. According to another aspect of the present invention, the workstation may further include a decision tree having a plurality of nodes, where each node of the decision tree specifies the filters to be applied, the windows to be analyzed, and the one or more classifiers to be applied to the representation of the histogram features. The object may be recognized by traversing one or more nodes of a decision tree until a terminal node is reached. The classifiers of the decision tree may be determined by comparing training set images to cross-validation set images. According to another aspect of the present invention, the at least one representation of the histogram features may be associated with projections of at least a portion of the histogram features onto a subspace of the histogram features space. In addition, at least one of the classifiers may operate in the subspace.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a system overview of an automated machine vision system according to an exemplary embodiment of the present invention.

FIG. 2 is a flow diagram for real-time object detection and recognition according to an exemplary embodiment of the present invention.

FIG. 3 illustrates an exemplary filter applied to an image according to an exemplary embodiment of the present invention.

FIG. 4 illustrates exemplary histogram features corresponding to local windows according to an exemplary embodiment of the present invention.

FIG. 5 is a flow diagram of the training process for an automated vision system according to an exemplary embodiment of the present invention.

FIGS. 6A and 6B illustrate exemplary target object images according to an exemplary embodiment of the present invention.

FIG. 6C illustrates exemplary background images according to an exemplary embodiment of the present invention.

FIG. 7 illustrates how one window can be represented as a combination of other windows according to an exemplary embodiment of the present invention.

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As will be appreciated by one of ordinary skill in the art, upon reading the following disclosure, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. Any suitable computer readable storage medium may be utilized including hard disks, CD-ROMs, optical storage devices, or magnetic storage devices.

The present invention is described below with reference to flowchart illustrations of methods, apparatus (i.e., systems) and computer program products according to an embodiment of the invention. It will be understood that each block of the flowchart illustrations, and combinations of blocks in the flowchart illustrations can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

System Overview

Embodiments of the present invention provide automated machine vision systems that allow for the real-time recognition of desired objects from an image or video source. For example, such an automated machine vision system may provide for facial recognition, which may be utilized as a form of biometric identification for security and access control. Likewise, the automated machine vision system can also provide for image-based surveillance for security and military applications. In addition, the automated machine vision system can provide for the identification of objects for industrial applications. Many more applications of the automated machine vision system will be readily apparent to one of ordinary skill in the art.

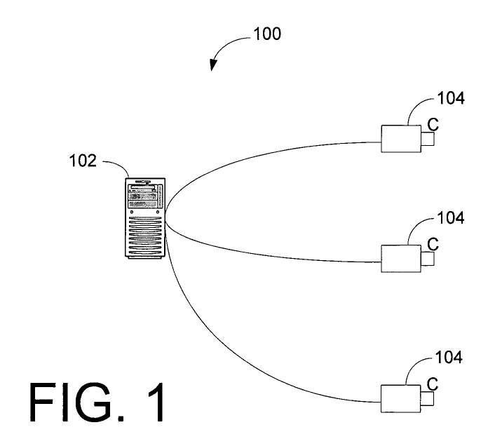

The automated machine vision system will now be discussed with reference to FIG. 1. As shown in the automated machine vision system 100, there is a workstation 102 and one or more imaging devices 104 in communication with the workstation 102. The workstation 102 can include one or more personal computers, field programmable gate array (FPGA) devices, application specific integrated circuits (ASICs), other microprocessors, and/or a combination thereof. The imaging devices 104 can include closed circuit television (CCTV) cameras, digital cameras, camcorders, web cameras, or any other sensor capable of providing images and/or video to the workstation 102. While not shown in FIG. 1, the imaging devices 104 or vision system 100 can also include one or more networks interconnecting the workstation 102 and the imaging devices 104. In addition, there may also be analog-to-digital converters for converting analog images and/or video into one or more digital formats as necessary. One of ordinary skill in the art will recognize that the imaging devices 104 and the workstation 102 could be incorporated in the same enclosure.

Overview of Real-time Object Recognition

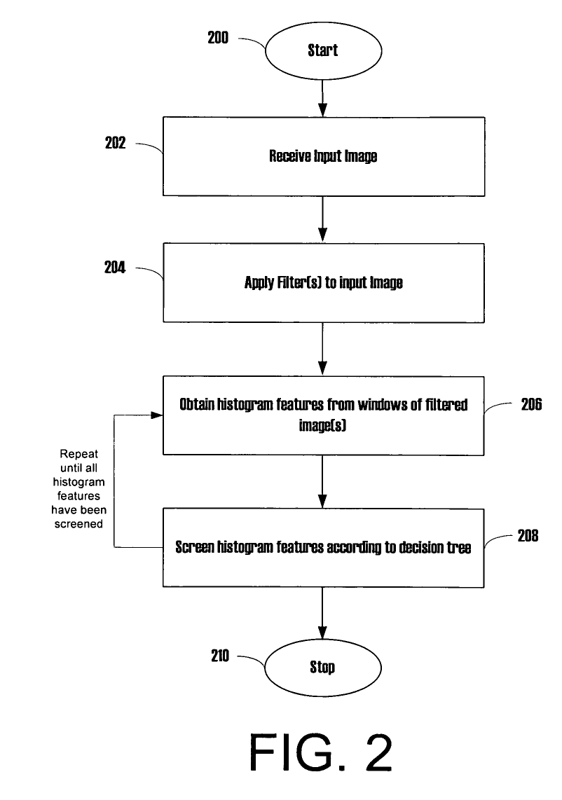

FIG. 2 illustrates an overview of the real-time object detection and recognition processes according to an exemplary embodiment of the present invention. As illustrated in block 202 of FIG. 2, an input image is received by the workstation 102. As described above, the input image can be received from one or more imaging devices 104. Having received the input image, the workstation 102 scans multiple windows of the input image, as objects of interest may appear at different scales and locations within the input image. For example, the workstation 102 may scan multiple windows proceeding from left to right and top to bottom, although other algorithms can be utilized. Each window can be viewed as a sub-image of the input image. For each sub-image, the workstation 102 proceeds to a node of a decision tree, as described below, stored at the workstation 102. Each node of the decision tree specifies the filters and/or window parameters (i.e., size, location relative to the sub-image) for determining the histogram features that are to be obtained from the received input images.

As illustrated in block 204, the workstation 102 filters the received input image using one or more filters. Local regions (“local windows”) of the filtered images are designated from which corresponding histogram features are obtained (block 206). Thus, the histogram features may be associated with a particular filter and window size and location. According to an exemplary embodiment of the present invention, these obtained histogram features may be known as topological local spectral histogram (TLSH) features, as will be described in further detail below. As illustrated by block 208, the obtained histogram features are screened according to the decision tree. In particular, at each node of the decision tree, the sub-image associated with the obtained histogram features will be classified. If the histogram features classify a window as representing background, the window is discarded. Those windows having histogram features that are classified as part of an object class are directed to other nodes for further classification until a terminal node is reached, thereby identifying the object in the window.

Histogram Features

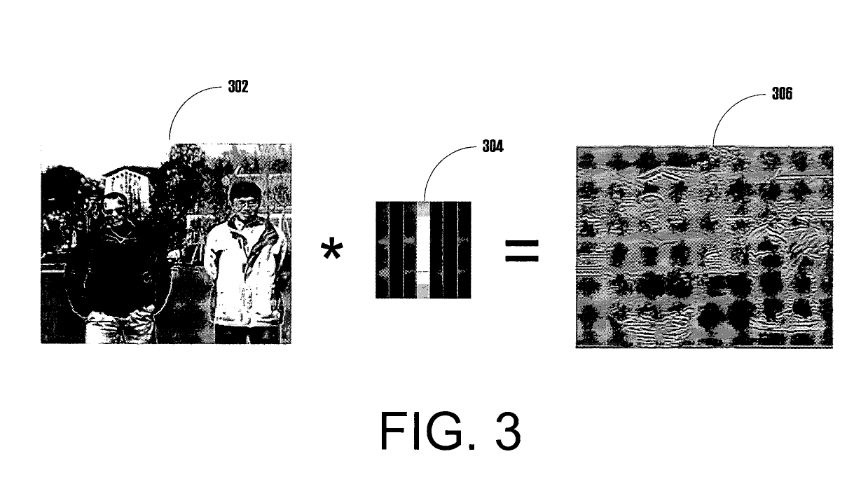

The histogram features obtained in block 206 and the associated filters in block 204 will now be discussed in further detail. With respect to block 204, one or more convolution filters or other types of filters can be applied to the input image according to an exemplary embodiment of the present invention. In accordance with an embodiment of the present invention, the filter response (i.e., the spectral component) or filtered image obtained by the convolution of an input image I and a convolution filter F can be provided by

$${I}^{F} ( {v}^{->} ) = F * I ( {v}^{->} ) = {\sum }_{{u}^{->}} F ( {u}^{->} ) I ( {v}^{->} - {u}^{->} ) ,$$

where \vec{v} is a given pixel location and the summation is taken over all pixel locations for the input image. FIG. 3 illustrates an example of an image 302, a filter 304, and the resulting filtered image 306.

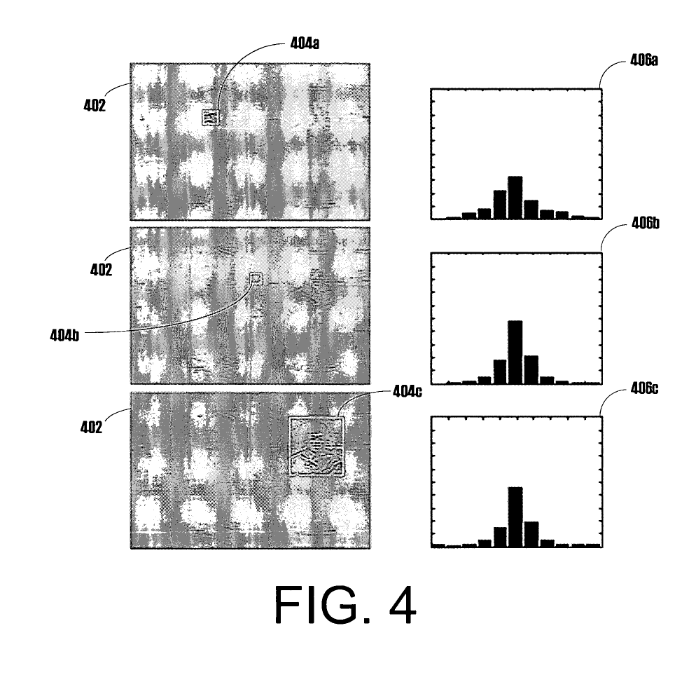

Once the image has been filtered according to one or more filters, a plurality of histogram features can be determined for each filtered image. For each filtered image, a plurality of local windows of varying sizes and locations can be specified. These local windows generally represent a particular region within the filtered image. For each local window, a histogram feature in the form of topological local spectral histogram (TLSH) feature can be specified according to an exemplary embodiment of the present invention. The TLSH feature of an filtered image I^{F} associated with a filter F and restricted to a window W in the image domain D can be defined as h(I, F, W). The bin of the TLSH feature, h(I, F, W), associated with a histogram range [z₁, Z₂) is given by

$$h ( I , F , W ) ( {z}_{1} , {z}_{2} ) = {\sum }_{{v}^{->} ∈ W} {\int }_{{z}_{1}}^{{z}_{2}} δ ( z - F * I ( {v}^{->} ) ) ⅆ z ,$$

where δ(·) is the Dirac delta function. FIG. 4 illustrates a filtered image 402 and local windows 404a, 404b, 404c of various sizes and locations along with the corresponding local spectral histogram 406a, 406b, 406c features.

According to an exemplary embodiment of the invention, a bank of filters ℑ={F₁, . . . , Fᵣ} can be can applied to an image along with a varying number of local windows to obtain a set of local spectral histogram features. The bank of filters and window parameters can be specified by a particular node in the decision tree, as discussed below. According to an exemplary embodiment of the present invention, if the scanned sub-images include 21×21 pixels, there may be 53,361 different TLSH features for each filter by varying the size and location of the local windows. In this situation, if there is a bank of 22 filters, there may be 1,173,942 TLSH features.

One of ordinary skill in the art will recognize that the use of a plurality of histograms of local windows allows TLSH features to effectively model patterns characterized by topological or geometric properties and/or textures. In particular, the TLSH features can still accurately characterize elements such as eyes and mouths that may be misaligned in the images. Further, by using multiple local windows, TLSH features can characterize rough topological relationships among local windows. For example, a full feature used for a decision at a node of a decision tree, as described below, may be a combination of several TLSH features. For instance, the full feature may be associated with 3 filters applied to 3 different windows: one covering the region near the eyes, one covering the nose area, and yet another covering the mouth. The combination of the three will thus contain information about the relative position of eyes, nose, and mouth in addition to texture and shape patterns observed in each of the regions.

Decision Trees

Decision trees were introduced above with respect to block 208 of FIG. 2. These decision trees allow the workstation 102 in the vision system 100 to identify whether a histogram feature associated with a particular local window includes an object or a background. These decision trees may include a plurality of nodes, where the nodes provide for discrimination between target objects and backgrounds or for discrimination between specific target objects. In particular, the nodes of the decision tree may specify particular filters and window parameters (i.e., size, location) for determining TLSH features. In addition, the nodes also provide the subspace onto which the vector of the TLSH features can be projected to reduce the dimension of the vector of TLSH features used at the node of the decision tree. The nodes may include classifiers for determining, based upon the projected TLSH features, whether the TLSH features indicate an object or background.

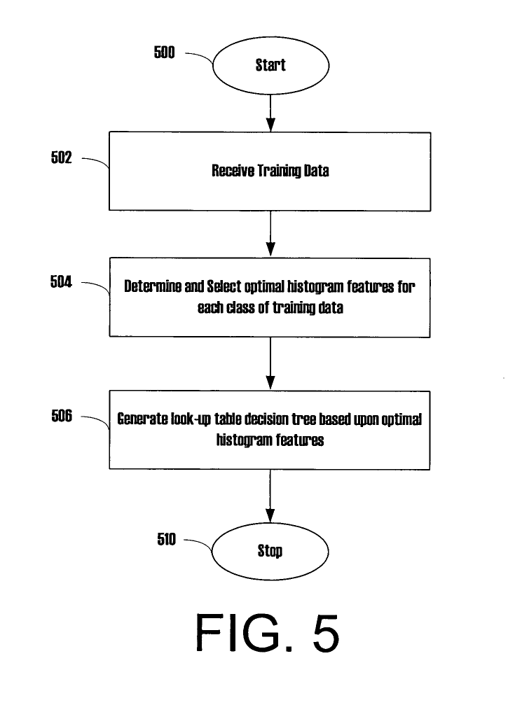

As described above, if the local window is classified by a node of the decision tree as an object, then the object can be recognized or identified by traversing to a terminal node of the decision tree. On the other hand, if the local window is classified as background, then the local window will be immediately discarded. The construction of the decision trees will be discussed with reference to FIG. 5 prior to discussing the operation of block 208 of FIG. 2 in further detail.

A. Construction of the Decision Trees

In accordance with an embodiment of the present invention, the decision trees can be constructed from a training database of images, as illustrated in FIG. 5. As illustrated in block 502 of FIG. 5, the workstation 102 initially receives access to training data, which may be stored in a training database accessible to the workstation 102. The training data includes images of objects that are to be detected and recognized as well generic images of expected backgrounds that the objects may likely be found within. In another embodiment of the present invention, because the construction of the decision tree precedes the use of the vision system for detection and recognition of objects, the construction of decision trees may be carried out on a separate workstation.

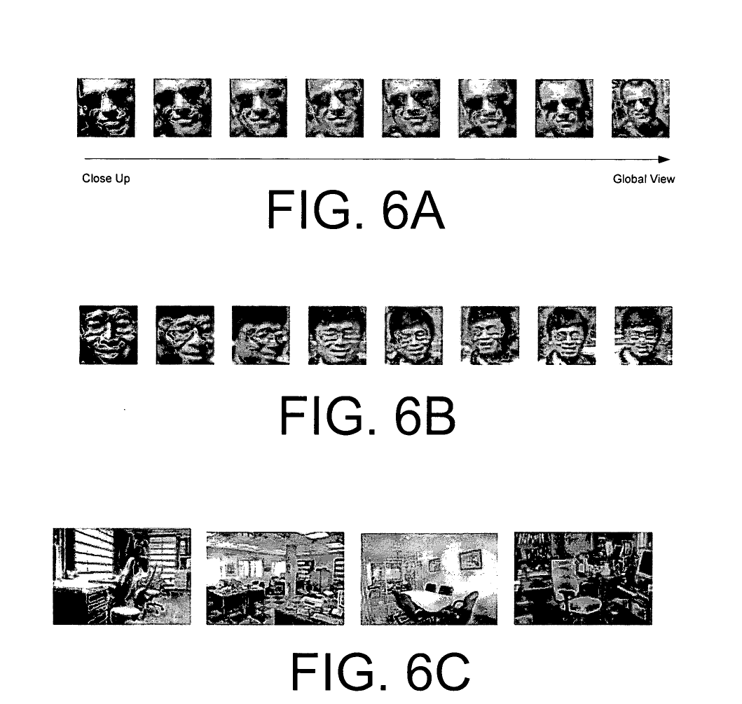

According to an exemplary embodiment of the present invention, each of the target objects images can be fixed in image size. Using such fixed-sized target object images, the target objects of interest can be characterized across multiple scales by including images ranging from a close-up scale to a more global scale, as illustrated by FIG. 6A. Further, the training images of a target object can also provide for views at different angles, as illustrated in FIG. 6B.

In addition to the images of the target objects in interest, the training database can also include generic images of expected backgrounds. The background images likely do not contain instances of the target objects. According to an exemplary embodiment of the present invention, the vision system 100 may be utilized in an office environment. The background images for this office environment may include generic images of typical offices, as illustrated in FIG. 6C. One of ordinary skill in the art will recognize that specific information about the environment of the vision system 100 is not necessary, but the recognition performance of the workstation 102 can be assisted by provided additional contextual information regarding the background. For example, if the workstation 102 receives images against a fixed background, significant computational gains may be achieved by using background subtraction techniques or reducing the number of background images utilized with the training database.

The above-described target object images and background images can be grouped into classes such as a target object class and a background class. For facial recognition applications, the target object class can include N classes of individuals that are to be recognized. Likewise, the background class can be subdivided into q classes of backgrounds, where similar background images may be associated with each class. For this example, the training database can include N+q classes of images.

The images in each class may also be divided into subcollections, which may be referred to as training sets and cross-validation sets. According to one embodiment of the present invention, the training set and corresponding cross-validation set may include images with similar views, including similar positions and angles. As will be described below, the training set images provide proposed features (e.g., local histogram features) that will be used to represent and characterize objects. On the other hand, cross-validation set images are provided to determine or gauge how good a proposed feature is for recognition and classification purposes. For example, if the use of a particular TLSH feature is unable to provide the necessary recognition and classification when applied to a cross-validation set image, then that particular feature may not be useful for object recognition. One of ordinary skill in the art will also recognize that the background images can also be provided with training set images and cross-validation set images as described above.

Referring to block 504 of FIG. 5, the training data within the training database is processed by the workstation 102 to determine and select the optimal local histogram features for the decision to be made at each node of the tree. As described with respect to block 502, this training data can include target object classes and background classes. Each class also includes training set images and cross-validation set images. One of ordinary skill in the art will readily recognize that clustering techniques, as described below, can be utilized to reduce the number of object classes.

The processing and selection of the optimal local histogram features, including the optimal TLSH features, includes searching over a given bank of filters and window parameters (i.e., position, dimension) for the decision to be made at a node of the tree. Generally, the selection algorithm for the optimal local histogram feature involves determining how well a particular collection of TLSH features identify cross-validation images as belonging to the correct class.

According to one embodiment of the present invention, the selection algorithm seeks to optimize a performance function G(F, W), which is a greedy algorithm with parameters filter F and window W. In particular,

$$G ( F , W ) = \frac{1}{K} {\sum }_{c = 1}^{K} \frac{1}{{v}_{c}} {\sum }_{i = 1}^{{v}_{c}} ϕ ( ρ ( {y}_{c , i} , F , W ) - 1 ) ,$$

where φ is a monotonically increasing bounded function and

$$ρ ( {y}_{c , i} , F , W ) = \frac{{min}_{d \neq c , j} d ( h ( {y}_{c , i} , f , W ) , h ( {x}_{d , j} , F , W ) )}{{min}_{j} d ( h ( {y}_{c , i} , F , W ) , h ( {x}_{c , j} , F , W ) ) ) + ɛ}$$

and where x_{c,1}, . . . , x_{c,t}_{_{c}} and y_{c,1}, . . . , y_{c,v}_{_{c}} represent the images in the training sets and validation sets, respectively, for a particular class c. Here, h denotes a histogram and d is the usual Euclidean distance between vectors.

In the above feature selection algorithm, the quantity ρ(y_{c,i}, f, W) measures how well a nearest-neighbor identifies a cross-validation set image y_{c,i} as belonging to class c. The value ε is typically greater than zero and a small number in order to prevent vanishing denominators. The monotonically increasing bounded function φ can be φ(x)=1/(1+e^{-2βx}), where the limit value of G(F,W), as β→∞, may be the recognition performance of the nearest-neighbor classifier.

In order to select the optimal TLSH feature, the value of the selection algorithm G(F,W) can be maximized, which indirectly maximizes the classification performance of the nearest-neighbor classifier. The above-described process for selecting the TLSH feature is repeated until the desired number of TLSH features have been selected.

Once the desired number of TLSH features for a decision problem have been selected, the set of TLSH features can be viewed as a vector. For example, if r different TLSH features have been selected, each associated with a histogram hᵢ with b bins, 1≦i≦r, then this set of TLSH features can be viewed as a vector H=(hᵢ, . . . ,hᵣ) in the feature space R^{rb}, the Euclidean space of dimension rb. Optimal component analysis (OCA), as described below, can be used to obtain a reduced linear subspace U of R^{rb}. OCA is a technique for finding an optimal low-dimensional subspace for the associated classification problem based upon the nearest neighbor criterion after projecting the data orthogonally onto the subspace. The obtained U-values are then quantized and decisions based on the nearest-neighbor classifier applied to the quantized U-values of features are recorded on a lookup table. Dimension reduction, as with OCA, may provide an efficient method for the workstation to store the lookup tables in memory. One of ordinary skill in the other will recognize that other alternatives can be utilized in addition or instead of OCA, including splitting factor analysis, as described below.

Once the desired number of TLSH features for each decision problem have been determined, the workstation 102 can construct a look-up table decision tree for real-time object detection and recognition, as illustrated in block 506. With the use of such a look-up table decision tree, a complex decision task can be represented as a hierarchy of simpler decisions. At each node of the look-up decision tree, decisions will be made, based at least in part on the nearest neighbor classifier, between or among a certain number of classes of images, each representing an object or background.

According to an exemplary embodiment of the present invention, all images representing target objects can be merged into a single class and all other images are placed in a single background class. Using OCA, a low-level classifier can be generated for detecting target objects—that is, to distinguish objects from backgrounds. However, according to another embodiment of the present invention, the background images can be subdivided into smaller subclasses and/or combined with some of the object classes using a clustering technique described in further detail below.

Based upon the classifications described above, a low-level binary classifier can be determined. The low-level classifier is obtained via OCA by projecting the H-representation, perhaps orthogonally, onto a subspace U of the full feature space. After quantizing the U-values, decisions made by the classifier based upon the U-values can be stored in a look-up table.

The above-described process is iterated for each additional node of the decision tree. At each node, training and cross-validation images representing k distinct classes are available. Using the clustering techniques described below, the number of classes may be reduced to enhance the recognition performance and efficiency of the vision system 100. A low-dimensional classifier for the corresponding node is constructed using the spectral histogram features and OCA. Classification results are then recorded for the node in a lookup table. The branching process is iterated until nodes only contain images representing a single target object. The final decision tree is a rooted tree whose nodes are labeled with a set of histogram features, a low dimensional subspace U of feature space, and a decision table. The leaves of the tree are labeled according to the object or background class they represent.

B. Utilization of the Decision Trees

Referring back to FIG. 2, as discussed with respect to block 206, histogram features can be obtained from local windows of the input image. In particular, these histogram features can be determined based upon a particular node of the decision tree. More particularly, for each window, staring from the root node and proceeding to the other nodes if needed, the relevant TLSH features are computed to produce a feature vector H, which is a collection of TLSH features, as described for “Fast Calculation of Features” below.

As described above, each node of the tree is labeled with a set of TLSH features, a low-dimensional subspace of feature space, and a lookup table. In accordance with block 208 of FIG. 2, once this feature vector H has been computed, it can be screened by the node of the decision tree. In particular, this screening process includes projecting the feature vector H onto the low-dimensional subspace associated with the node, and converted to an entry in the lookup table at the node. This lookup table instructs the workstation 102 as how to classify the local window according to the classifier. At the root node, most local windows will be classified as background and will be immediately discarded. Those that are placed in some object class will be directed to other nodes, where the process is iterated until a terminal node is reached—that is, until the object that the local window represents is identified. Because decisions at each node of the decision tree are recorded on a lookup table, the average processing time can be significantly reduced.

Optimal Component Analysis

Optimal Component Analysis (OCA), as introduced above, will now be discussed in further detail. Given a dataset consisting of points in Euclidean space R^{m} representing several different classes of objects, OCA may provide a technique for finding an optimal low-dimensional subspace for solving the associated classification problem based on the nearest neighbor criterion (or variants such as k-nearest neighbors) after projecting the data orthogonally to the subspace.

According to one embodiment of the present invention, labeled training and cross-validation sets consisting of representatives of P different classes of objects may be provided. For each class c, 1≦c≦P, x_{c,1}, . . . , x_{c,t}_{_{c}} and y_{c,1}, . . . , y_{c,v}_{_{c}} can denote the elements in the training and validation sets, respectively, that belong to class c. Given an r-dimensional subspace U of R^{m} and x, yεR^{m}, let d(x, y; U) denote the distance between the orthogonal projections of x and y onto U. The quantity

$$ρ ( {y}_{c , j} ; U ) = \frac{{min}_{d \neq c , j} d ( {y}_{c , i} , {x}_{d , j} ; U )}{{min}_{j} d ( {y}_{c , i} , {x}_{c , j} ; U ) + ɛ}$$

measures how well the nearest-neighbor classifier applied to the data projected onto U identifies the element Y_{c,i} as belonging to class c. Here, ε>0 is a small number used to prevent vanishing denominators. Let

$$G ( U ) = \frac{1}{P} {\sum }_{c = 1}^{P} \frac{1}{{v}_{c}} {\sum }_{i = 1}^{{v}_{c}} ϕ ( ρ ( {y}_{c , j} \text{:} U ) - 1 ) ,$$

where φ is a monotonically increasing bounded function. A common choice is φ(x)=1/(1+e^{-2βx}), for which the limit value of G(U), as β→∞, is precisely the recognition performance of the nearest-neighbor classifier after orthogonal projection to the subspace U. Let [symbol] _{m,r} be the Grassmann manifold, whose elements are the r-dimensional vector subspaces of R^{m}. An optimal r-dimensional subspace for the given classification problem from the viewpoint of the available data is given by

$$\hat{U} = {arg max}_{{Uεg}_{m , r}} G ( U ) .$$

An algorithm for estimating Û is described in X. Liu, A. Srivastava, and K. Gallivan, Optimal linear representations of images for object recognition, IEEE Trans. Pattern Analysis and Machine Intelligence 26 (2004), 662-666.

Splitting Factor Analysis

While several exemplary embodiments of the present invention have utilized Optimal Component Analysis (OCA), one of ordinary skill in the art will recognize that other dimension reduction techniques can be utilized. In particular, an alternative to OCA is Splitting Factor Analysis.

Splitting Factor Analysis (SFA) is a linear feature selection technique in which the goal is to find a linear transformation that reduces the dimension of data representation while optimizing the predictive ability of the K-nearest neighbor (KNN) classifier as measured by its performance on given training data. According to an embodiment of the present invention, assume that a given ensemble of data in Euclidean space R^{m} is divided into training and cross-validation sets, each consisting of labeled representatives from P different classes of objects. For an integer, c, 1≦c≦P, x_{c,1}, . . . , x_{c,t}_{_{c}} and y_{c,1}, . . . , y_{c,v}_{_{c}} can denote the training and cross-validation images, respectively, that belong to class c.

If A: R^{m}→R^{k} is a linear transformation and x, yεR^{m}, d(x, y; A)=∥Ax−Ay∥ can denote the distance between the transformed points Ax and Ay. The quantity

$$ρ ( {y}_{c , i} ; A ) = \frac{{min}_{c \neq b , j} {d}^{p} ( {y}_{c , i} , {x}_{b , j} ; A )}{{min}_{j} {d}^{p} ( {y}_{c , i} , {x}_{x , j} ; A ) + ɛ}$$

provides a measurement of how well the nearest-neighbor classifier applied to the transformed data identifies the cross-validation element Y_{c, i} as belonging to class c. Here, ε>0 is a small number used to prevent vanishing denominators and p>0 is an exponent that can be adjusted to regularize ρ in different ways in accordance with an embodiment of the present invention. A large value ρ(y_{c, i}; A) may indicate that, after the transformation A is applied, y_{c, i} lies much closer to a training sample of the class it belongs than those of other classes; ρ(y_{c, i}; A)≈1 may indicate a transition between correct and incorrect divisions by the nearest neighbor classifier. One of ordinary skill in the art will recognize that ρ(y_{c, i}; A) may be modified to reflect the performance of the KNN classifier.

In accordance with an embodiment of SFA, a transformation A may be chosen that maximizes the average value of ρ(y_{c, i}; A) over the cross-validation set. To control bias with respect to particular classes, ρ(y_{c, i}; A) may be scaled with a sigmoid of the form σ(x)=1/(1+e^{-βx}) before taking the average. One can identify linear maps A: R^{m}→R^{k} with k×m matrices and define a performance function F: R^{kxm}→R by

$$F ( A ) = \frac{1}{P} {\sum }_{c = 1}^{P} ( \frac{1}{{v}_{c}} {\sum }_{i = 1}^{{v}_{c}} σ ( ρ ( {y}_{c , i} ; A ) - 1 ) ) .$$

For a given A, the limit value of F(A), as β→∞ and ε→0, is the recognition performance of the nearest neighbor classifier applied to the transformed data.

In accordance with an embodiment of SFA, scaling an entire dataset may not change decisions based on the nearest neighbor classifier. This may be reflected in the fact that F can be nearly scale invariant; that is, F(A)≈F(r A), for r>0. Equality does not hold if ε≠0, but practically, ε is negligible. Thus, F can be restricted to transformations of unit norm. Let S={AεR^{kxm}:∥A∥²=tr(AA^{T})=1}be the unit sphere in R^{kxm}. According to an embodiment of the present invention, a goal of splitting factor analysis may be to maximize the performance function F over S: that is to find Â=argmax F(A). The existence of a maximum of F is guaranteed by the fact that the sphere S is a compact space and F is continuous.

Due to the existence of multiple local maxima of F, the numerical estimation of Â is carried out with a stochastic gradient search, as similarly employed in OCA, but much perhaps simpler since it may be performed over a sphere instead of a Grassmann manifold.

Clustering

Clustering, as introduced, above will now be discussed in further detail. According to one embodiment of the present invention, the entire recognition workflow is structured in the form of a lookup-table decision tree, which allows for a very complex decision task to be expressed as a hierarchy or more simply decision tasks. According to aspect of the present invention, given a test image, a large number of sub-windows can be scanned for content in a relatively short time. More specifically, those sub-windows that are unlikely to contain relevant information will be quickly discarded. On the other hand, the workstation 102 may focus attention on the few sub-windows that are likely to represent a target object.

At each node of the decision tree, decisions will involve k classes of images, each representing a target object or background. A step towards simplifying the data structure at that node may be to lower the number of classes to some l<k. For instance, at the top level of the decision tree, all objects of interest may be grouped into a single class, such that there are only two classes—targets and backgrounds. This particular grouping may be straightforward since images in the database can be labeled according to the class they represent, but in general, it still is advantageous to have an algorithmic clustering procedure. At a typical node, all background images may be placed in a single class and clustering may be applied to the training images representing subjects. For this purpose, images can be represented using histograms of their (global) spectral components, and hierarchical clustering algorithms can be used to merge the classes of images.

More specifically, given an image I and a bank of convolution filters F={F₁, . . . , Fᵣ}, let I₁, . . . , Iᵣ denote the corresponding spectral components. Let H=(h, h₁, . . . , hᵣ), where h and hᵢ, 1≦i≦r, are the histograms of the original image and the ith spectral component, respectively. If each histogram has a fixed number b of bins, then H can be viewed as a vector R^{b}× . . . ×R^{b=}R^{(r+1)b}. The vector H is used to represent the image I for clustering purposes. Using the H-representation, the given k classes of images can be viewed as k classes of points in Euclidean space. Starting from k classes, each consisting of a single image, hierarchical clustering algorithms well-known to those of ordinary skill in the art can be used to reduce the number of clusters to l. According to an aspect of the invention, the closest clusters can be iteratively merged until the desired number is reached. According to another aspect of the invention, at each step, the distance between centroids of current clusters can be used as the merging criterion. According to yet another aspect of the invention, clusters can be merged so that cluster sizes are well-balanced. This may be desirable if all subjects are known to be represented by approximately the same number of images in the training database. This is done by successively merging clusters, as described above, except that images are no longer added to a cluster once it contains approximately k/l images.

Fast Calculation of Features

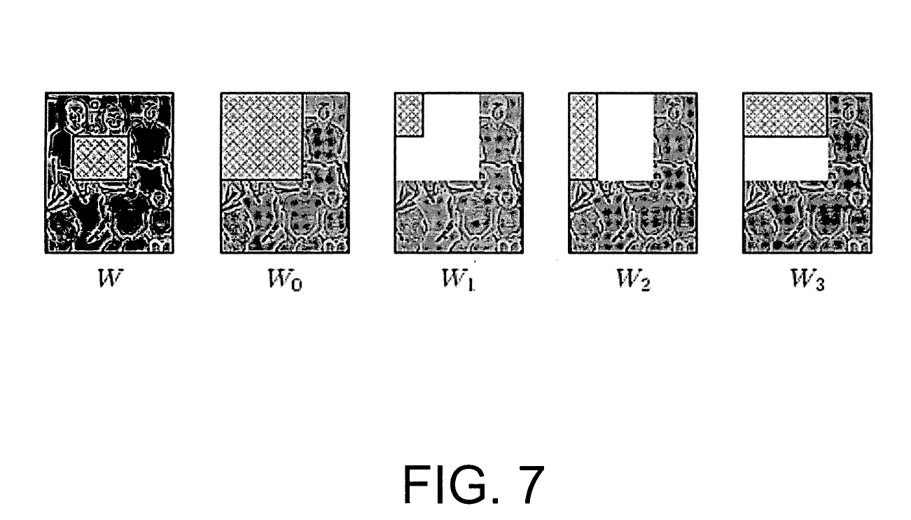

According to an embodiment of the present invention, TLSH features associated with a given spectral component of an image can be computed using a small number of instructions. The use of a small number of instructions provide for real-time execution of TLSH-based recognition tasks and also makes training the workstation 102 more efficient. As described above, calculating h(I, F, W) for a local window W requires a summation over all the pixels in W. For W=W0+W1−W2−W3, as illustrated in FIG. 7, this yields

$$h ( I , F , W ) ( {z}_{1} , {z}_{2} ) = h ( I , F , {W}_{0} ) ( {z}_{1} , {z}_{2} ) + h ( I , F , {W}_{1} ) ( {z}_{1} , {z}_{2} ) - h ( I , F , {W}_{2} ) ( {z}_{1} , {z}_{2} ) - h ( I , F , {W}_{3} ) ( {z}_{1} , {z}_{2} ) .$$

Now, for each bin [z₁, z₂), h(I, F, W)(z₁, z₂) can be evaluated with a small number of instructions using a variant of the notion of integral image. For the bin [z₁, z₂), the value of histogram integral image H(I, F) at pixel (x,y) is H(I, F)(x, y)=h(I, F, W_{xy})(z₁, Z₂), where W_{xy} is the window with northwestern and southeastern corners (0, 0) and (x, y), respectively. W₀, W₁, W₂, and W₃ in FIG. 7 are examples of such windows. The equation for h(I, F, W) provides that, through the histogram integral image, h(I, F, W) can be computer using 3×L operations, where L is the number of bins in the histogram. According to an aspect of the present invention, this number can be further reduced. For example, in a 720×480 image, the accumulated number in any bin can be at most 720×480=345, 600<2²⁰. This indicates that only 20 bits are necessary to represent any bin. By using a 128-bit word available in SSE2 and SSE3 instructions, 6 bins can be encoded in a single word. This reduces the number of operations to compute one TLSH feature to 3×[L/6] by processing all bins in one word at the same time. For L≦6, there may be only three instructions needed to compute a TLSH feature. The computational complexity of an integral image is linear in the number of pixels.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for real-time object recognition, comprising:
receiving at least one image from at least one imaging device;
obtaining a plurality of histogram features from the at least one image, wherein obtaining the plurality of histogram features includes:
applying one or more filters to the received images to generate one or more filtered images; and
analyzing one or more windows of the filtered images for obtaining the histogram features;
obtaining at least one representation of the histogram features;
recognizing an object in the at least one received image by applying one or more classifiers to the representation of the histogram features.

2. The method of claim 1, wherein analyzing one or more windows of the filtered images includes a summation of a plurality of pixels of the one or more windows.

3. The method of claim 1, wherein recognizing the object includes recognizing the object by traversing one or more nodes of a decision tree until a terminal node is reached, wherein each node of the decision tree specifies the filters to be applied, the windows to be analyzed, and the one or more classifiers to be applied to the representation of the histogram features.

4. The method of claim 3, wherein the classifiers of the decision tree are determined by comparing training set images to cross-validation set images.

5. The method of claim 1, wherein obtaining at least one representation of the filtered images includes projecting at least a portion of the histogram features onto a subspace of the histogram features space.

6. The method of claim 5, wherein at least one of the classifiers operates in the subspace.

7. The method of claim 1, wherein recognizing the object includes recognizing the object in the at least one received image by applying one or more classifiers to the representation of the histogram features in accordance with one of optimal component analysis and splitting factor analysis.

8. A method for training a vision system for real-time object recognition, comprising:
receiving a plurality of training data having a plurality of classes of target objects and backgrounds, wherein the training data includes training set images and cross-validation set images for each class;
retrieving histogram features from the training data, wherein each histogram feature is associated with a filter and a window;
determining optimal histogram features for one or more classes; and
storing classifiers for the optimal histogram features in one or more nodes of a decision tree, wherein each node of the decision tree provides for discrimination between classes based upon representations of histogram features retrieved from input images.

9. The method of claim 8, wherein determining the optimal histogram features includes determining the recognition performance of the histogram features of the training set images when applied to the cross-validation set images.

10. The method of claim 8, further comprising clustering at least a portion of the plurality of classes in order to obtain a smaller number of classes of target objects and backgrounds.

11. The method of claim 8, further comprising storing filters and windows associated with the optimal histogram features in one or more nodes of the decision tree, wherein the nodes determine at least in part which histogram features of the input images are retrieved.

12. The method of claim 8, wherein receiving a plurality of training data includes receiving, for each class of target objects, images of target objects at varying scales.

13. The method of claim 8, wherein retrieving histogram features from the training data includes applying one or more filters to the training data, obtaining a window of the filtered training data, and performing a summation of a plurality of pixels within the window.

14. A system for real-time object recognition, comprising:
an imaging device for providing input images;
a workstation in communication with the imaging device for receiving the at least one input image, wherein the workstation is operative to:
apply one or more filters to the at least one input image to generate one or more filtered images;
analyze one or more windows of the filtered images to obtain the histogram features;
obtain at least one representation of the histogram features; and
recognize an object in the at least one received image by applying one or more classifiers to the representation of the histogram features.

15. The system of claim 14, wherein the histogram features are associated with a summation of a plurality of pixels of the one or more windows.

16. The method of claim 14, wherein the workstation further includes a decision tree having a plurality of nodes, wherein each node of the decision tree specifies the filters to be applied, the windows to be analyzed, and the one or more classifiers to be applied to the representation of the histogram features.

17. The method of claim 16, wherein the object is recognized by traversing one or more nodes of a decision tree until a terminal node is reached.

18. The method of claim 16, wherein the classifiers of the decision tree are determined by comparing training set images to cross-validation set images.

19. The method of claim 14, wherein the at least one representation of the histogram features are associated with projections of at least a portion of the histogram features onto a subspace of the histogram features space.

20. The method of claim 19, wherein at least one of the classifiers operates in the subspace.
